(19) United States
(12) Patent Application Publication
(10) Pub. No.: US 2006/0238039 A1
(43) Pub. Date: Oct. 26, 2006

(54) STEP MOTOR VALVE ASSEMBLY WITH FAIL-SAFE FEATURE

(75) Inventors: John F. Niedermeyer, Woodbury, CT (US); Lyman W. Wycoff, Indianapolis, IN (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: Parker-Hannifin Corporation, Cleveland, OH (US)

(21) Appl. No.: 11/278,880

(22) Filed: Apr. 6, 2006

Related U.S. Application Data
(60) Provisional application No. 60/668,903, filed on Apr. 6, 2005.

(51) Int. Cl. H02K 37/14; H02K 7/06; F16K 31/02

(52) U.S. Cl. 310/49 R; 310/80; 251/129.11; 123/339.26

(57) ABSTRACT

A step motor valve assembly comprises a housing including a threaded portion, a rotor having rotational axis and a threaded portion in threaded engagement with the threaded portion of the housing such that rotation of the rotor will effect axial movement of the rotor relative to the housing, a valve member carried by the rotor for axial movement toward and away from a valve seat upon rotation of the rotor in respective opposite directions, and a return mechanism for moving the valve member to a fail-safe position upon a loss of power to the step motor valve assembly.

### RELATED APPLICATION

This application claims the benefit of U.S. Provisional Application No. 60/668,903 filed Apr. 6, 2005, which is hereby incorporated herein by reference in its entirety.

### FIELD OF THE INVENTION

The invention herein described relates generally to step motor valve assemblies and more particularly to a step motor valve assembly with a failsafe feature.

### BACKGROUND

Step motor valves, also referred to as stepper motor valves, are used to control a variety of fluids in industrial systems. A major limitation of many step motor valves is that upon a loss of power they remain at their last commanded position. In some applications this can be detrimental, i.e. the valve could be full open, full closed or any position in between. Electrical battery or capacitor back-up system solutions heretofore have been proposed to supply emergency power to the stepper drive to force it to a known, desired fail-safe position.

Another solution has been to include in the fluid flow circuit a separate solenoid-operated fail-safe valve which is normally biased to a fail-safe position. When power is supplied to the system, the fail-safe valve is moved to an open position for normal system operation of the step motor valve. If there is a power failure, the fail-safe valve will under the mechanical action of the spring move to its fail-safe position and override the step motor valve.

U.S. Pat. No. 4,501,981 describes a linear stepper motor that is provided with a feature to cause it to return to a zero position when current is cut off. The motor is formed of a stator assembly and a permanent magnet rotor assembly with poles thereof facing poles of the stator assembly. The rotor assembly, which is journalled for rotational movement only, includes a rotor core formed as a nut with an axial threaded aperture extending therethrough. A shaft assembly includes a shaft screw mating with the rotor core nut, a front shaft affixed thereto, and a fixed sleeve overfitting the front shaft to permit axial motion thereof. A ball-and-groove arrangement in the front shaft and the sleeve prevents rotation of the shaft without impairing axial movement thereof. A spring causes return of the shaft to zero when there is no current applied to the stator assembly. The spring can be a coil compression spring overfitting a portion of the shaft or a spiral torsion spring extending between the rotor and the stator assembly.

Such type of mechanical return device does not lend itself to stepper motor valves wherein the rotor assembly moves not only rotationally but also axially. One such stepper motor valve is disclosed in Korean Utility Patent No. 0211748. A rotor has an externally threaded portion that engages an internally threaded nut that is formed integrally with or joined to a valve body including a valve chamber. The rotor is contained within a housing interiorly communicating with the valve chamber, and the housing is externally surrounded by a stator assembly that magnetically interacts with the rotor to effect rotation of the rotor. Upon energization of the stator assembly surrounding the rotor, the rotor is caused to rotate and turn in the nut. As the rotor turns, it will move axially to in turn move a needle valve carried by the rotor. That is, rotation of the rotor moves the rotor axially to move the valve into or out of engagement with a valve seat.

### SUMMARY OF THE INVENTION

The present invention provides a mechanical fail-safe solution for step motor valves in which the opening and closing of the valve is effected by rotation of a rotor that not only rotates but also moves axially. The solution may be accomplished without the need for backup electrical power or separate fail-safe valves.

Accordingly, the invention provides a step motor valve assembly comprises a housing including a threaded portion, a rotor having rotational axis and a threaded portion in threaded engagement with the threaded portion of the housing such that rotation of the rotor will effect axial movement of the rotor relative to the housing, a valve member carried by the rotor for axial movement toward and away from a valve seat upon rotation of the rotor in respective opposite directions, and a return mechanism for moving the valve member, particularly a spring-loaded compliant valve member, to a fail-safe position upon a loss of power to the step motor valve assembly.

The housing may include a valve body including the valve seat, a valve chamber and inlet and outlet passages communicating with the chamber with one of the passages opening to the valve chamber at the valve seat, and a shell having an interior in fluid communication with the valve chamber. The shell may have the rotor located therein, and the valve assembly may further comprise a stator assembly exteriorly surrounding the shell for magnetically interacting with the rotor to effect rotation of the rotor when power is controllably applied to the stator assembly.

In one embodiment, the return mechanism may include a spiral torsion spring that is fixed at a first end against rotation relative to the housing and is fixed at an opposite second end against rotation relative to the rotor. The first end of the torsion spring may be a radially inner end of the torsion spring, and at least one end of the torsion spring may be free to move axially relative to the housing or rotor to which it is fixed against relative rotation, thereby to accommodate axial movement of the rotor. The spiral torsion spring may be maintained in a planar configuration by axially adjacent walls of a spring case that may be axially inserted into the housing.

In a further embodiment, the return mechanism may include magnetically coupled first and second coupling members, the first coupling member being fixed for rotation with the rotor and the second coupling member being axially spaced from and magnetically coupled to the first coupling member such that the first and second coupling members commonly rotate; and a return device connected to the second coupling member for returning the second coupling member to a fail-safe position upon a loss of power to the step motor valve, whereupon the rotor and in turn the valve member will be moved to respective fail-safe positions. The return device may be located outside the shell with the second coupling member magnetically interacting with the first coupling member through a magnetically transparent wall portion of the shell. The second coupling member and return device may be mounted in a case that can be selectively attached to the shell, whereby the step motor valve assembly can operate without a fail-safe feature when the case is not attached to the shell and with a fail-safe feature when the case is attached to the shell.

In another embodiment, the threaded portion of the housing may be movable axially relative to the valve seat and biased by the return mechanism to an axial fail-safe position when no power is being supplied to the step motor valve assembly. When power is applied, the threaded portion may be moved to a commutating position.

In a further embodiment, the threaded portion may be a nut movable axially in a bore in a valve body and constrained against rotation relative to the valve body. There may be provided a radially movable cam member and a cam follower surface on the threaded portion cooperative with the cam member to move the threaded portion from its fail-safe position to its commutating position upon radial movement of the cam member from a first position to a second position. The cam member may be magnetically actuable. The threaded portion may also include a closure portion operable to block flow of fluid through the step motor valve assembly when the threaded portion is in its fail-safe position.

According to still another embodiment, the threaded portion of the housing may include a closure portion and be movable relative to the valve seat between a fail-safe position at which the closure portion is operable to block flow of fluid through the step motor valve assembly and an open position permitting flow through the step motor valve assembly, and the return mechanism may be operable to move the threaded portion to the fail-safe position upon a loss of power to the step motor valve assembly. The threaded portion may rotate relative to the valve seat or may move axially relative to the valve seat.

The foregoing and other features of the invention are hereinafter more fully described and particularly pointed out in the claims, the following description setting forth in detail certain illustrative embodiments of the invention, these being indicative, however, of but a few of the various ways in which the principles of the invention may be employed.

### BRIEF DESCRIPTION OF THE DRAWINGS

In the annexed drawings:

FIG. 1 is a cross-sectional view of a step motor valve assembly according to the invention;

FIG. 2 is a cross-sectional view of another step motor valve assembly according to the invention;

FIGS. 2A-2C are plan and perspective views showing two alternative techniques for coupling the rotor to the return spiral spring.

FIG. 3 is a cross-sectional view of another step motor valve assembly according to the invention;

FIG. 4 is a cross-sectional view of another step motor valve assembly according to the invention;

FIG. 5 is a cross-sectional view of another step motor valve assembly according to the invention;

FIG. 6 is a cross-sectional view of another step motor valve assembly according to the invention;

FIG. 7 is a cross-sectional view of another step motor valve assembly according to the invention;

FIG. 8 is a schematic illustration of another step motor valve assembly according to the invention;

### DETAILED DESCRIPTION

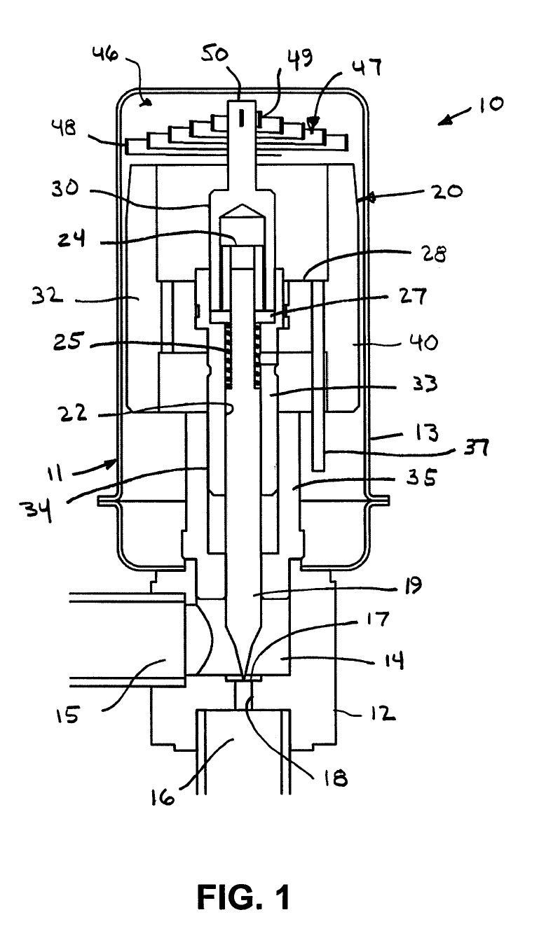

Referring now in detail the drawings and initially to FIG. 1, an exemplary step motor valve assembly according to the invention is designated generally by reference numeral 10. The illustrated step motor valve assembly 10 has particular application in a refrigeration cycle system and particularly as an expansion valve for controlling fluid flow to an expansion orifice. Although the invention is illustrated by reference to such type of valve, those skilled in the art will appreciate that the principles of the invention will have applicability to other types of step motor valves. In this specification reference may be had to upper, lower, above, below, etc. in relation to the orientation of the step motor valve assembly illustrated in the drawings. This is done as a matter of convenience inasmuch as the step motor can be otherwise oriented. Accordingly, such positional relationships are not intended to limit the step motor valve assembly to a particular orientation unless otherwise herein expressly indicated.

The step motor valve assembly 10 generally comprises a housing 11 which in the illustrated embodiment includes a valve body 12 and a shell 13 joined to the valve body. The valve body includes a valve chamber 14 and inlet/outlet passages 15 and 16, one of which opens to the valve chamber at a valve seat 17 that is associated with an orifice 18. A valve member 19, such as a valve needle, is movable toward and away from the valve seat 17 to control the flow of fluid through the valve assembly 10 and more particularly the orifice 18. The direction of flow may be in either direction, although preferably flow is from the passage 15 to the passage 16.

The valve member 19 is carried by a rotor 20 located within the interior of the shell 13 that may be in fluid communication with the valve chamber 14 whereby the interior of the shell is flooded with the working fluid being controlled by the step motor valve assembly 10 (in effect the shell 13 functions as a pressure vessel in fluid communication with the valve chamber 14). In the illustrated embodiment a middle portion of the valve member 19 is supported in the rotor 20 for relative axial movement. This may be effected by providing the rotor with an axial center bore 22 in which the middle portion of the valve member is supported for telescoping movement. The valve member 19 is captured in the rotor by a bushing 24 secured to the upper end of the valve member, and the valve member is biased downwardly by a resilient member such as a coil spring 25. The coil spring is interposed between a shoulder on valve member and a stop collar 27 retained in an upwardly open counterbore in a web portion 28 of the rotor. The counterbore has secured therein an arbor 30 that includes a downwardly opening center bore in which the bushing 24 can move axially with axial movement of the valve member 19. Since there are no additional gear reductions and the valve member is spring loaded, the valve member resists binding and causes no wear to the valve seat 17.

The rotor 20 may be of any suitable construction. In the illustrated embodiment the rotor has a plastic portion 32 molded to a center screw portion 33 in which the upper end of the valve member is slidably received as above described. The center screw portion has an externally threaded portion 34 depending from the web portion 28 of the rotor. The threaded portion is meshed with an internally threaded nut 35 that may be formed integrally with or joined to the valve body 12. Accordingly, rotation of the rotor will case the rotor to rotate relative to the nut 35 and thus screw into and out of the nut depending on the direction of rotation. This axial movement of the rotor will cause axial movement of the valve member 19 toward and away from the valve seat 17. Suitable stops 37 may be provided in known manner to limit the rotation of the rotor in one or both rotational directions and/or one or both axial directions, as may be desired for a particular application.

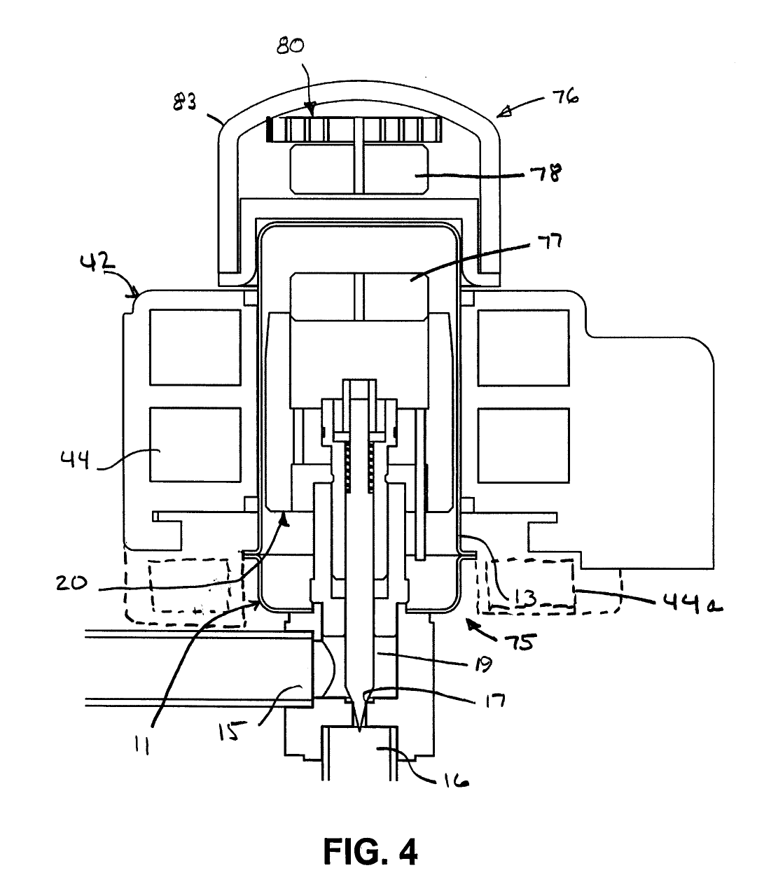

The rotor 20 has a radially outer tubular portion 40 positioned close to the inner surface of the shell 13. The tubular portion has magnetic media disposed therein to form magnetic poles that magnetically interact with the magnetic fields imposed thereon by a stator assembly 42. An exemplary stator assembly 42 is shown in FIG. 4. As shown in FIG. 4, the stator assembly 42 is a removable component that can be telescoped over the housing shell 13 for magnetic interaction with the rotor 20. The stator assembly may be of a conventional construction such that upon energization the rotor is caused to rotate a prescribed amount. The electrical windings 44 of the stator are contained within the external stator assembly and thus are isolated from the working fluid by the shell 13. The shell preferably is made of a thin, magnetically transparent material, at least in the region of the rotor and stator assembly, to allow the magnetic field or fields generated by the stator windings 44 to pass through the wall of the shell.

In accordance with the present invention, a return mechanism 46 is provided for moving the valve member 19 to a fail-safe position upon a loss of power to the step motor valve assembly 10. In the FIG. 1 embodiment, the return mechanism 46 includes a spiral torsion spring 47 that is fixed at one end 48 against rotation relative to the housing and is fixed at an opposite end 49 against rotation relative to the rotor 20. As shown, the radially inner end of the torsion spring may be fixed to the rotor. More particularly, the inner end of the torsion spring is anchored to a pin end 50 of the rotor arbor 30. Because the rotor moves axially as well as rotationally, the spiral torsion spring not only works in the plane of its winding, but also telescopes in a conic shape to the extent of the full stroke capability of the rotor and valve member.

Although the arrangement shown in FIG. 1 is workable, the spiral spring 47 may be negatively impacted by the problem of “caging”. This phenomena arises when the spring, when telescoped, becomes unstable and buckles into a ball-like configuration. This can arise from a combination of a weak spiral spring made of a thin material and the conical deformation during rotation and axial movement of the rotor. The spring may need to be weak as to allow it to be overcome by the magnetic field acting on the rotor. Additionally, a spring that is rigidly attached at each end of its coils may also add complexity to the manufacturing and assembly of the step motor valve assembly.

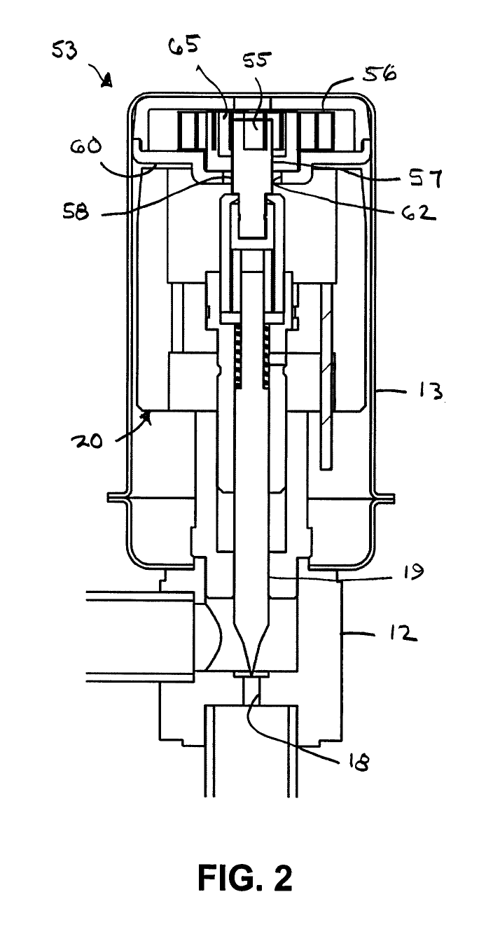

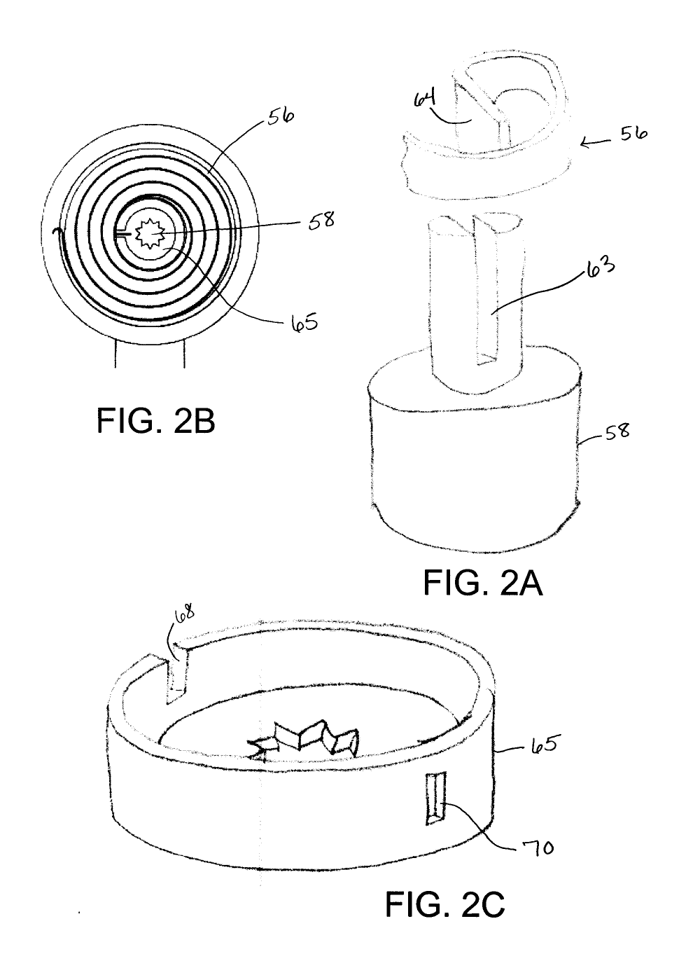

Consequently, a more preferred construction is shown in FIG. 2, wherein the same reference numerals are used to designate the corresponding parts described above in connection with the FIG. 1 embodiment (likewise for the remaining figures). As will be appreciated, the construction shown in FIG. 2 reduces potential failure modes while allowing for ease of assembly and manufacture.

The step motor valve assembly 53 shown in FIG. 2 is essentially the same as the step motor valve assembly 10 shown in FIG. 1. However, the inner end of the spiral spring 56 is not fixed to the rotor arbor. Instead, it is provided with an axial slip connection 55 such as a loop in which the end of the rotor arbor pin 57 is restrained against relative movement in the plane of the coil spring while allowing the pin to move axially relative to the plane of the coil spring. In a preferred construction, the spiral spring is contained in a spring case 60 that maintains the coils of the spring 56 coplanar. That is, the case prevents any significant “coning” of the spiral spring. The case will also facilitate assembly of the spiral spring in the shell. For some applications, the spring may be pre-stressed to optimize the torque gradient and the required revolutions for the application while minimizing material usage and package size.

More particularly, the outer end of the coil spring 56 may be fixedly attached to the coil case 60, which in turn may be press fit, adhesively bonded, or otherwise suitably secured to the shell 13. The inner coil end may have a loop 55 that mates with the pin at the end of the rotor arbor that passes through an aperture 62 in the wall of the spring case. The arbor 58 can translate and rotate with the rotor 20. The arbor pin, however, may have a slot of sufficient length to accommodate the full stroke of the rotor. The arbor end will translate axially through the loop of the spiral spring while remaining engaged and thereby imparting its rotation energy to the spring. With this arrangement, the spiral spring can be maintained in the plane on which it is wound and will not be susceptible to caging. The slotted end of the arbor can be aligned at assembly to pass through the clearance hole 62 in the case 60 and properly engage the loop at the inner end of the spring. The opposite end of the arbor will be rigidly attached to the rotor assembly.

More particularly, the arbor can be seen in FIG. 2A to include a reduced width neck including a slot 63 for receiving an inwardly bent tab 64 at the inner end of the spiral spring. The tab and slot are free to shift axially with respect to one another. In an alternative exemplary arrangement shown in FIGS. 2B and 2C, the arbor could be splined as shown (or provided with another type or anti-rotation device, e.g. D-shaped, keyed, etc.). The splined end of the arbor may be received in an correspondingly shaped hole in the bottom of a cup-shape coupling member 65. The outer wall of the coupling member may be provided with a slot 68 or hole 70, either of which can receive a tab on the end of the spiral spring. The coupling member is free to move axially relative to the arbor to accommodate axial shifting of the rotor.

The spiral spring 56 will store the energy imparted to open the valve in the case of a normally closed valve or the energy imparted to close the valve in the case of a normally open valve. That is, if the valve has only opened one turn (or closed one turn for a normally open valve) then the energy associated with one turn is stored in the spring. The largest deflection (turns or revolutions) requirement would be when the valve is fully opened and that is when the spring has its maximum deflection (turns or revolutions) stored. In addition, the valve configuration may normally operate in an over-seat flow direction where the high-side pressure is contained with the shell 13 and is throttled through the orifice 18 to the low side pressure of the system. In this flow orientation the valve closure will be assisted by the pressure differential created across the orifice. Conversely, the spring return feature will also be imparting a minimal additional force to oppose the initial opening of the valve.

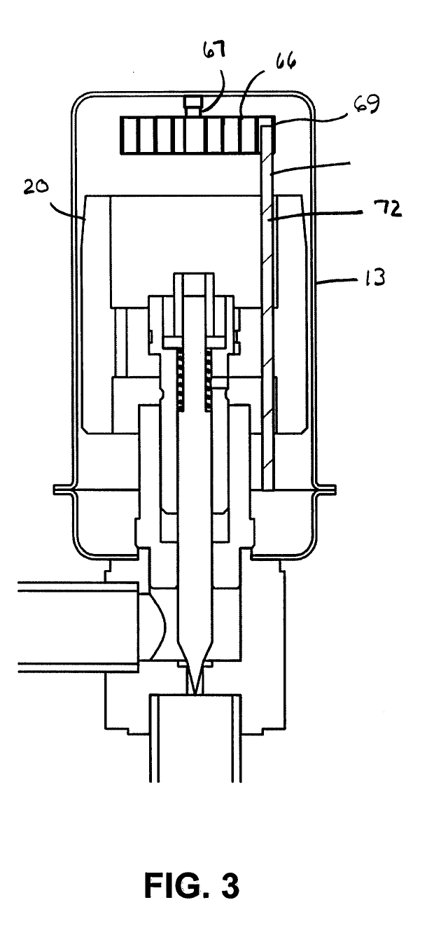

A modified version of the FIG. 2 construction is shown in FIG. 3. In this version, the inner end of the spiral torsion spring 66 is fixed to an arbor 67 that protrudes from the center of the thin walled shell 13. The outer coil end has an axial slip connection 69 such as a loop that engages an extended pin 72 that is fixedly attached to the rotor 20 and permits movement of the pin axially through its center. The version, however, is less preferred because as the spiral spring is wound on the central arbor, it will tend to impart an increasing lateral movement and force toward the rotor axis. This potentially could cause the rotor to bind or miss steps during actuation. In addition, this configuration is less favorable to assembly as the spring may not be easily pre-stressed, may be difficult to attach at the arbor and may require more exact alignment at final assembly.

Another embodiment is shown in FIG. 4. In the step motor valve assembly 75 shown in FIG. 4, the return mechanism 76 includes magnetically coupled inner and outer coupling members 77 and 78. The inner coupling member 77 is fixed for rotation with the rotor 20 and the outer coupling member 78 is axially spaced from and magnetically coupled to the inner coupling member such that the inner and outer coupling members commonly rotate. A return device 80, such as a spiral spring, is connected to the outer coupling member for returning the outer coupling member to a fail-safe position upon a loss of power to the step motor valve assembly, whereupon the rotor and in turn the valve member will be moved to respective fail-safe positions. One of the coupling members may be made of a ferromagnetic material and the other may be a permanent magnet, or both may be magnets.

As in the other embodiments, the housing 11 includes a valve body 12 including the valve seat 17, a valve chamber 14 and inlet and outlet passages 15 and 16 communicating with the chamber with one of the passages opening to the valve chamber at the valve seat 17, and a shell 13 having an interior in fluid communication with the valve chamber. The shell has the rotor 20 and the inner coupling member 77 located therein, and the outer coupling member 78 and the return device 80 are located outside the shell 13 with the second coupling member magnetically interacting with the first coupling member through a magnetically transparent wall portion of the shell. The second coupling member and return device may be mounted in a case 83 that can be selectively attached to the shell, whereby the step motor valve assembly can operate without a fail-safe feature when the case is not attached to the shell and with a fail-safe feature when the case is attached to the shell. As in the case of the other embodiments, the stator assembly 42 exteriorly surrounds the shell 13 for magnetically interacting with the rotor to effect rotation of the rotor when power is controllably applied to the stator assembly, and the stator assembly may include a housing removably mountable to the shell.

As the rotor 20 turns it will wind the spiral spring 80 attached to the outer coupling member 78 and store the rotational energy. On loss of holding power or signal, the coil spring will unwind and force the valve closed. The normally closed valve configuration strengthens this coupling in that the coupling members will be moving to closer proximity as the valve is opened and will better resist the stored torque energy that is increased in the spiral spring.

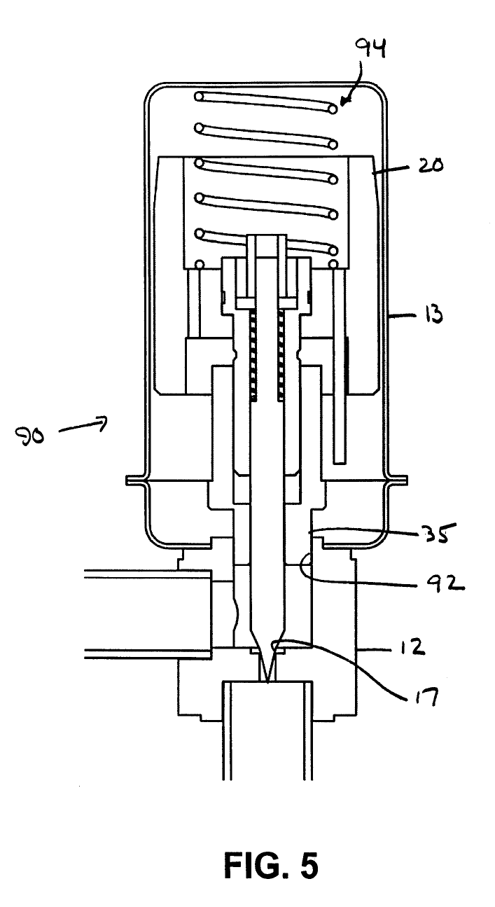

Referring now to FIG. 5, another step motor valve assembly 90 is shown. In this embodiment, an internally threaded nut 35 is assembled with an axial slip fit to the valve body 12 but constrained against rotation relative to the valve body. The rotational constraint may be provided by the nut 35 and bore 92 in which the nut slides having a non-circular cross-section, whereby the nut and bore have rotationally interfering surfaces that preclude rotation of the nut in the bore. As will be appreciated, other means non-rotation means may be employed, such as the use of a key and slot.

The nut 35 is biased by a return device 94 to an axial fail-safe position when no power is being supplied to the step motor valve assembly. When power is supplied, the nut is moved to a commutating position.

More particularly, the return device 94 includes a compression spring interposed between the rotor and end wall of the shell. The spring in the un-powered state of the valve will force the rotor and nut toward the valve seat 17 to cause the valve member to close against the valve seat. When power is applied to the stator assembly (or a secondary stator if needed to generate sufficient force), the rotor is moved into its commutation position. The valve member and spring may be of sufficient length to accommodate the initial startup stroke and still provide compliant spring force shut-off at the valve seat. That is, the axial shifting movement is such as to bring the rotor to the point that further movement of the rotor will unseat the valve member from the valve seat. From this position the valve operates as normal and holding current to the stator assembly (and/or secondary stator) keeps the rotor assembly drawn into the correct axial location for commutation.

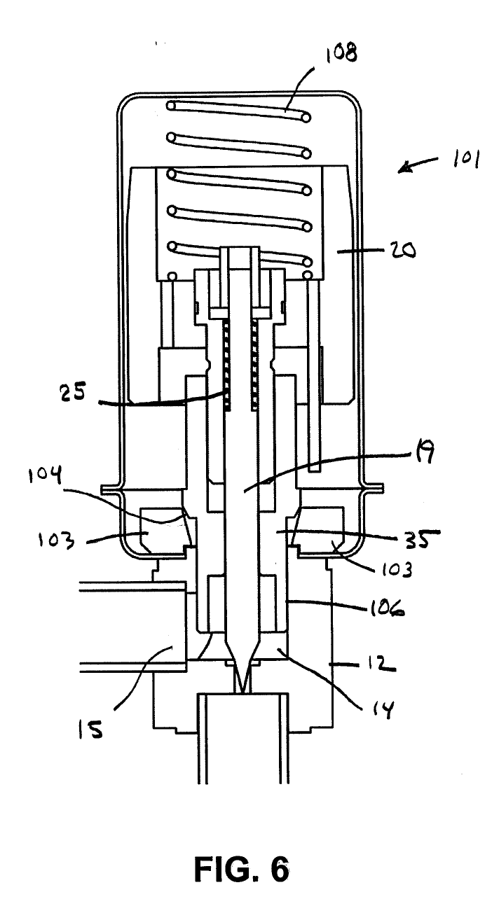

FIG. 6 shows another step motor valve assembly 101 wherein the internally threaded nut 35 is assembled with a slip fit to the valve body 12 as above described. In this embodiment, the return mechanism includes one or more radially movable cam members 103 that engage a follower surface 104 on the nut that has a depending valve closure portion 106. More particularly, the nut has an angled or beveled surface 104, and the cam members are opposed wedges that when moved together, will urge the nut from its fail-safe position shown in FIG. 6 to a raised commutation position at which the rotor 20 will be properly located in relation to the stator assembly (FIG. 4) for normal commutation. A compression spring 108 acts in opposition to the wedge parts in order to separate them in an un-powered state of the valve. This allows the nut to shift downwardly so that the valve portion 106 thereof will close off the passage 15 opening to the valve chamber 14, thereby shutting off flow through the valve.

The wedge parts 103 are solenoid actuated, such that when power is supplied to the valve, a solenoid is energized to move the wedge members toward one another to urge the rotor upwardly to its normal operating position. The solenoid, for example, may be a separate set of windings 44a located in the stator assembly (shown in broken lines) which, when energized, causes the wedge members to move toward one another. Preferably such shifting movement is such as to bring the rotor to the point that further movement of the rotor will unseat the valve member 19 from the valve seat. That is, such movement corresponds to the compliance movement of the valve member biasing spring 25.

The dual wedge parts could be replaced with a single cylindrical part that has a helical cam surface on its internal diameter that would interact with a helical cam surface on the external diameter of the body nut on the cam surfaces at initial start up. This would reposition the body nut to the commutation position and allow for standard valve operation.

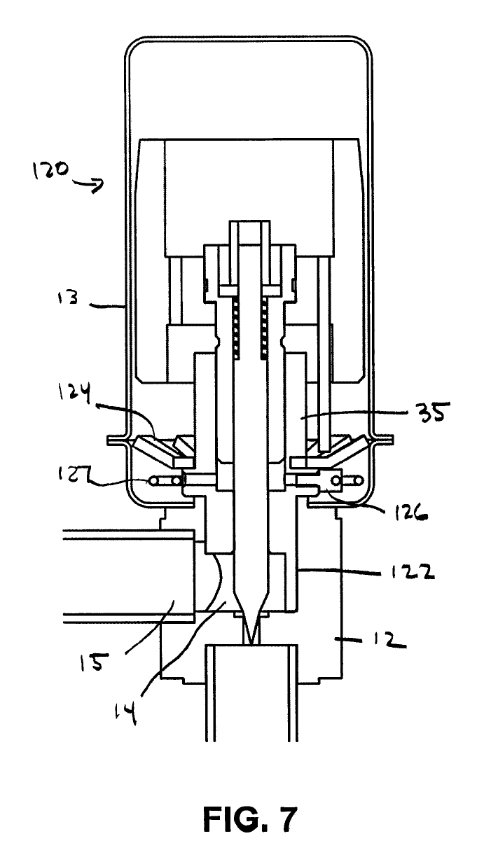

Another step motor valve assembly 120 is shown in FIG. 7. Like the valve assembly shown in FIG. 6, the internally threaded nut 35 is assembled with a slip fit to the valve body 12 as above described. The depending valve portion 122 of the nut, however, is operative to open and close the passage 15 opening to the valve chamber 14 upon rotation of the nut which in this embodiment is restrained against axial movement relative to the valve body 12 by means of a retaining washer 124 that defines an inner envelope at the bottom of the shell 13. The return mechanism includes a magnet or magnetically attracted target 126 located within the inner envelope of the shell and attached to the nut 35. Also attached to a shoulder on the nut is a torsion spring 127. A solenoid, which may be formed by a separate set of windings in the stator assembly, similar to windings 44a in FIG. 4, is provided to rotate the nut from a valve closed position to a valve open position seen in FIG. 7 when power is supplied to the step motor valve assembly. For example, the valve portion can be configured to open and close the valve through just a quarter turn of movement. As the nut is rotated, the spring will store energy sufficient enough to rotate the nut to its fail-safe position if power to the valve is lost. If power failed in the normally closed valve position, the needle would provide a secondary shut off at the orifice seat.

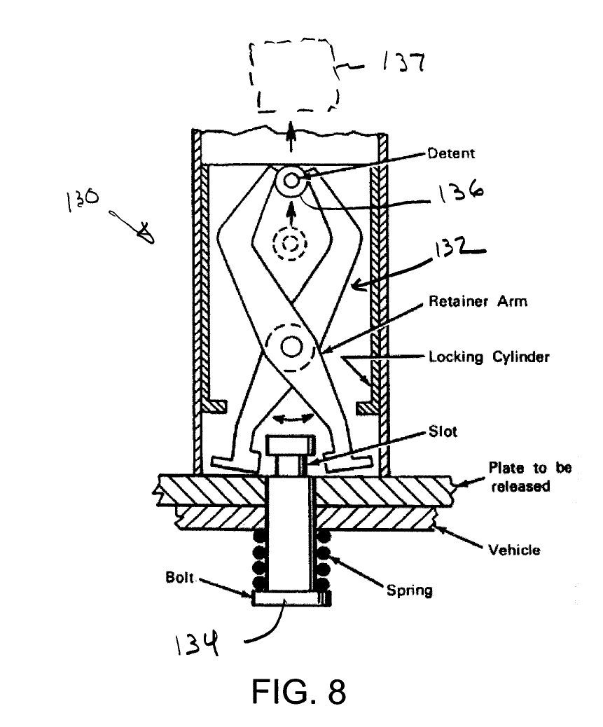

FIG. 8 schematically illustrates another embodiment of the invention. The return mechanism 130 illustrated in FIG. 8 may be incorporated in a step motor valve assembly like that shown in FIG. 1. The return mechanism includes a quick release mechanism 132 that would be contained within the upper part of the shell. The mechanism would capture the valve member retainer bushing 134 and would be triggered by a moveable detent 136 that may be spring activated. A secondary solenoid coil 137 may be used to set the mechanism on power up and draw the detent and subsequently the bushing and valve member into a standard valve position. The stroke of the detent would be greater than the overall stroke of the valve needle. On power loss, the spring would return the detent and release the jaws or fingers that capture the valve member bushing thereby allowing the needle to close against the orifice seat. Examples of quick release mechanisms that could be used are familiar to those in the art.

Although the invention has been shown and described with respect to a certain embodiment or embodiments, it is obvious that equivalent alterations and modifications will occur to others skilled in the art upon the reading and understanding of this specification and the annexed drawings. In regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A step motor valve assembly comprising a housing including a threaded portion, rotor having rotational axis and a threaded portion in threaded engagement with the threaded portion of the housing such that rotation of the rotor will effect axial movement of the rotor relative to the housing, a valve member carried by the rotor for axial movement toward and away from a valve seat upon rotation of the rotor in respective opposite directions, and a return mechanism for moving the valve member to a fail-safe position upon a loss of power to the step motor valve assembly.

2. A step motor valve assembly as set forth in claim 1, wherein the return mechanism includes a spiral torsion spring that is fixed at a first end against rotation relative to the housing and is fixed at an opposite second end against rotation relative to the rotor.

3. A step motor valve assembly as set forth in claim 2, wherein the first end of the torsion spring is a radially inner end of the torsion spring.

4. A step motor valve assembly as set forth in claim 2, wherein at least one end of the torsion spring is free to move axially relative to the housing or rotor to which it is fixed against relative rotation, thereby to accommodate axial movement of the rotor.

5. A step motor valve assembly as set forth in claim 2, wherein the spiral torsion spring is maintained in a planar configuration by axially adjacent walls of a spring case.

6. A step motor valve assembly as set forth in claim 5, wherein the spring case is axially inserted into the housing.

7. A step motor valve assembly as set forth in claim 1 any preceding claim, wherein the housing includes a valve body including the valve seat, a valve chamber and inlet and outlet passages communicating with the chamber with one of the passages opening to the valve chamber at the valve seat, and a shell having an interior in fluid communication with the valve chamber, the shell having the rotor located therein, and further comprising a stator assembly exteriorly surrounding the shell for magnetically interacting with the rotor to effect rotation of the rotor when power is controllably applied to the stator assembly,

8. A step motor valve assembly as set forth in claim 1, wherein the return mechanism includes magnetically coupled first and second coupling members, the first coupling member being fixed for rotation with the rotor and the second coupling member being axially spaced from and magnetically coupled to the first coupling member such that the first and second coupling members commonly rotate; and a return device connected to the second coupling member for returning the second coupling member to a fail-safe position upon a loss of power to the step motor valve, whereupon the rotor and in turn the valve member will be moved to respective fail-safe positions.

9. A step motor valve assembly as set forth in claim B, wherein the housing includes a valve body including the valve seat, a valve chamber and inlet and outlet passages communicating with the chamber with one of the passages opening to the valve chamber at the valve seat, and a shell having an interior in fluid communication with the valve chamber, the shell having the rotor and the first coupling member located therein, and the second coupling member and the return device being located outside the shell with the second coupling member magnetically interacting with the first coupling member through a magnetically transparent wall portion of the shell.

10. A step motor valve assembly as set forth in claim 9, wherein the second coupling member and return device are mounted in a case that can be selectively attached to the shell, whereby the step motor valve assembly can operate without a fail-safe feature when the case is not attached to the shell and with a fail-safe feature when the case is attached to the shell.

11. A step motor valve assembly as set forth in claim 10, further comprising a stator assembly exteriorly surrounding the case for magnetically interacting with the rotor to effect rotation of the rotor when power is controllably applied to the stator assembly, and wherein the stator assembly includes a housing removably mountable to the shell.

12. A step motor valve assembly as set forth in claim 1, wherein the threaded portion of the housing is movable axially relative to the valve seat, the threaded portion is biased by the return mechanism to an axial fail-safe position when no power is being supplied to the step motor valve assembly, and the threaded portion is movable to a commutating position power is being supplied to the step motor valve assembly.

13. A step motor valve assembly as set forth in claim 12, wherein the threaded portion is a nut movable axially in a bore in a valve body and constrained against rotation relative to the valve body.

14. A step motor valve assembly as set forth in claim 12, further comprising a radially movable cam member and a cam follower surface on the threaded portion cooperative with the cam member to move the threaded portion from its fail-safe position to its commutating position upon radial movement of the cam member from a first position to a second position.

15. A step motor valve assembly as set forth in claim 14, wherein the cam member is magnetically actuable.

16. A step motor valve assembly as set forth in claim 12, wherein the threaded portion includes a closure portion operable to block flow of fluid through the step motor valve assembly when the threaded portion is in its fail-safe position.

17. A step motor valve assembly as set forth in claim 1, wherein the threaded portion of the housing includes a closure portion and is movable relative to the valve seat between a fail-safe position at which the closure portion is operable to block flow of fluid through the step motor valve assembly and an open position permitting flow through the step motor valve assembly, and the return mechanism is operable to move the threaded portion to the fail-safe position upon a loss of power to the step motor valve assembly.

18. A step motor valve assembly as set forth in claim 17, wherein the threaded portion rotates relative to the valve seat.

19. A step motor valve assembly as set forth in claim 17, wherein the threaded portion moves axially relative to the valve seat.
